(19) United States
(12) Patent Application Publication
(10) Pub. No.: US 2005/0150372 A1
(43) Pub. Date: Jul. 14, 2005

(54) Thrust device

(76) Inventors: Danh Luan Nguyen, Schwaebisch Gmuend (DE); Marco Grau, Schwaebisch Gmuend (DE); Oliver Hetzel, Waldstetten (DE); Erich Berroth, Birkenlohe (DE)

Correspondence Address: JORDAN AND HAMBURG LLP, 122 EAST 42ND STREET, SUITE 4000, NEW YORK, NY, 10168, US

(21) Appl. No.: 11/035,879

(22) Filed: Jan. 10, 2005

Related U.S. Application Data
(63) Continuation of application No. PCT/EP03/06429, filed on Jun. 18, 2003.

(30) Foreign Application Priority Data
Jul. 8, 2002 (DE) 102 30 602.8
Jul. 8, 2002 (DE) 102 30 600.1
Jun. 5, 2003 (DE) 103 25 518.4

(51) Int. Cl. F16K 31/12

(52) U.S. Cl. 91/508

(57) ABSTRACT

A thrust device, in particular for a roller cam mechanism in a steering system, includes a first mechanism member which is held on a frame in engagement with a second mechanism member. The thrust device comprises a pressure piece which is mounted on the frame so as to be displaceable along an axis and is acted on by a spring element for pressing the first and second mechanism members against one another. In order to construct the thrust device for compensating for wear and thermal expansion of the engagement of the mechanism members and to configure it to be inexpensive and quiet during operation, there is provision for the spring element to be formed from rolling bodies which are spring loaded approximately transversely with respect to the axis of the pressure piece, the rolling bodies being supported on oblique surfaces between the pressure piece and a frame part which is configured as a setting screw or cover. The pressure piece can additionally be spring loaded axially by a compression spring.

### BACKGROUND OF THE INVENTION

The invention relates to a thrust device, in particular 5 for a roller cam mechanism in a steering system.

DE 100 51 306 A1 describes a gear mechanism, in particular for a vehicle steering system, having a pinion which is configured as a first mechanism member and is connected fixedly to a drive shaft of a servomotor so as to rotate with it. The pinion is in engagement with a second mechanism member which is configured as a gear wheel. The drive shaft is held pivotably in a locating bearing and a floating bearing. The floating bearing is held radially displaceably in a frame which is configured as a mechanism casing. The floating bearing is pressed onto the gear wheel by a spring element in the radial direction via a supporting ring which serves as a pressure piece. The supporting ring is held radially displaceably in a slot in the mechanism casing and is secured against rotation via the spring element.

During operation of the gear mechanism, the development of noise by the thrust device cannot be ruled out, as the pressure piece comes into contact with the mechanism casing when the drive shaft is pivoted to its maximum, structurally predefined extent.

DE 38 35 947 A1 describes a steering system which is configured as a rack and pinion steering system for a motor vehicle and has a rack which is guided axially displaceably in a frame which is configured as a casing. A pinion which is connected fixedly to a steering handle so as to rotate with it is inserted into the casing, the pinion meshing with toothing of the rack. The pinion forms a first mechanism member and the rack forms a second mechanism member. A pressure piece which is arranged in the casing so as to be displaceable along an axis, is acted on by a spring element and acts on the rear side of the rack ensures a lack of play between the pinion and the toothing of the rack.

In addition, an adjusting element is arranged in series with the spring element and produces a lack of play in the arrangement of the pressure piece and the spring element. In this way, a thrust device is represented which avoids rattling noise in the casing during operation of the steering system. The thrust device has a multiplicity of components and the installation space of the thrust device is not minimized.

### SUMMARY OF THE INVENTION

The invention is based on the object of providing a thrust device for mechanism members which makes low-noise operation of the mechanism members possible with a simple construction and a thrust force which can be varied in a narrow range.

The thrust device has a spring element which makes it possible to act on the pressure piece permanently with a spring force which varies in a narrow range and also ensures constant contact of fixed components between the pressure piece and the frame, as viewed in the radial direction of the mechanism members, as a result of which impact between the components of the thrust device and the development of noise is avoided. Instead of providing a thrust device having a plurality of devices for adjusting the pressure piece and for action by a spring force, the thrust device has a spring element which both makes possible permanent application of a spring force which varies in a narrow range to the pressure piece and also has a self-adjusting function.

For this purpose, as viewed in the axial direction of the axis of the pressure piece, the spring element is arranged between the pressure piece and a frame part on which the first and second mechanism members are held. The spring element comprises rolling bodies which are spring loaded approximately transversely with respect to the axis of the pressure piece and are supported in each case at least on an oblique surface. Here, the oblique surface is configured in each case obliquely with respect to the axis of the pressure piece at an angle which opens radially toward the axis or at an angle which opens obliquely away from the axis. Accordingly, the rolling bodies are spring loaded with a spring in the radial direction away from or toward the axis, and are pressed in each case against the oblique surfaces. In order, in particular, to minimize hysteresis of the spring element, a further spring which is configured as a compression spring can be arranged between the pressure piece and the frame part and act on the pressure piece and/or the spring which loads the rolling bodies.

Preferred refinements of the invention emerge from the subclaims.

If the oblique surfaces are arranged at an angle which opens radially toward the axis of the pressure piece, it is expedient to arrange the spring in such a way that it is supported on rolling bodies which in each case lie diametrically opposite the axis and acts on the latter with a spring force.

The oblique surfaces merge in each case with an arcuate segment into a flat surface which extends approximately perpendicularly with respect to the axis of the pressure piece. The arcuate segment has a larger radius than the rolling bodies which slide and/or roll on the oblique surfaces and the flat surface. The oblique surfaces can be arranged on the pressure piece on its end surface which faces the frame part. It can also be expedient to arrange the oblique surfaces and the flat surface in the frame part.

The respective component (pressure piece or frame part) which, in the axial direction of the axis of the pressure piece, lies opposite the component which bears the oblique surfaces preferably has a flat end surface on which the rolling bodies slide and/or roll. Radial stops for the rolling bodies can be arranged on the end surface. The arcuate segments form radial stops for the rolling bodies with the opposite surface and therefore a stop for the pressure piece.

In order to minimize costs, the rolling bodies are preferably configured as spherical components or balls. The compression spring which acts on the pressure piece or the spring in the axial direction can have a greater spring force than the spring which loads the rolling bodies. The spring force of the compression spring is preferably as much as approximately 20 N. The frame part on which the spring element is supported is preferably a setting screw which can be adjusted in the axial direction with respect to the pressure piece. It can be expedient to provide a cover or a crossmember instead of the setting screw and to position the cover fixedly in the frame with a form-fitting connection, preferably by calking. In order to ventilate the space between the pressure piece and the cover or the setting screw, a hole is provided in the pressure piece which penetrates the pressure piece in the axial direction. The frame in which the first and second mechanism members are arranged is expediently configured as a preferably closed mechanism casing.

It can be expedient to provide a cover or a crossmember instead of the setting screw and to position the cover fixedly in the frame with a form-fitting connection, preferably by calking. The frame in which the first and second mechanism members are arranged is expediently configured as a preferably closed mechanism casing.

It is expedient to allow the pressure piece to act on a 30 radially displaceably mounted bearing of the first or second mechanism member.

The spring element according to the invention brings about a permanent contact between solid, metallic components, as a result of which impact noise is avoided during operation of the thrust device. A thrust force which varies within narrow limits and can be predefined is made possible by the thrust device, with the simultaneous possibility of automatic adjustment for the purpose of compensating for tolerances as a result of wear or thermal expansion.

One exemplary embodiment is shown in the following text using the drawings.

### BRIEF DESCRIPTION OF THE DRAWINGS

FIG. 1 shows a partial cross section through a rack and pinion steering system in the region of the thrust device,

FIG. 2 shows a partial cross section through a worm gear mechanism having a thrust device,

FIG. 3 shows a longitudinal section through the thrust device from FIG. 2, and

FIG. 4 shows a longitudinal section through a thrust device having a compression spring.

### DESCRIPTION OF THE PREFERRED EMBODIMENTS

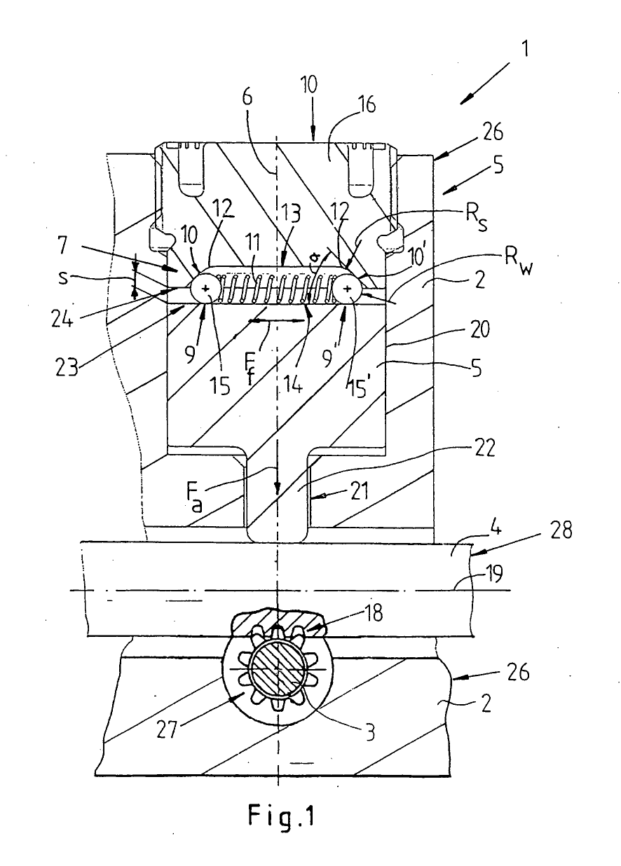

FIG. 1 partially shows a cross section of a steering system which is configured as a rack and pinion steering system for a motor vehicle. Here, a frame 2 which is configured as a mechanism casing 26 is shown in the axial direction with respect to a rack 28 in the region of a thrust device 1. The rack 28 bears toothing 18 which extends over the rack 28 in the axial direction and is in engagement with a pinion 27 which is connected fixedly to the end of a steering shaft so as to rotate with said steering shaft.

The pinion 27 is mounted rotatably in the mechanism casing 26 in a manner which is not shown in greater detail and forms a first mechanism member 3. The rack 28 is displaced in the axial direction as a function of a rotation of the pinion 27 at a steering handle on the steering shaft. The rack 28 forms a second mechanism member 4 and is connected to steerable wheels of the motor vehicle using steering tie rods and wheel steering levers.

The toothing 18 of the rack 28 is pressed against the pinion 27 with the aid of a pressure piece 5 which is arranged in the mechanism casing 26 so as to be axially displaceable along an axis 6 which is arranged perpendicularly with respect to the longitudinal axis 19 of the rack 28. The pressure piece 5 can be cylindrical or cuboid and is inserted in a hole 20 in the mechanism casing 26. In its axial end which faces the rack 28, the hole 20 has an opening 21 through which a pressure piece end 22 protrudes which is in sliding contact with the rack 28.

A spring element 7 which is inserted in the hole 20 is supported on a base 23 of the pressure piece 5 which is configured as a flat surface 14. The spring element 7 is supported in the axial direction of the axis 6 on a frame part 10 which is configured as a setting screw 16.

The spring element 7 is formed from two rolling bodies 8, 8′ which lie opposite one another diametrically with respect to the axis 6 and are configured as balls 15, 15′. A spring 11 which is configured as a helical compression spring is inserted between the rolling bodies 8, 8′, the radius of the helical compression spring and the radius R_{w} of the rolling bodies 8, 8′ being approximately identical.

A frustoconical turned groove is made in an end surface 24 of the setting screw 16 which lies opposite the base 23 of the pressure piece 5 at the spacing s. In the cross section shown, the turned groove has oblique surfaces 9, 9′ which are configured in each case with an angle α which opens radially toward the axis 6.

As viewed in the radial direction with respect to the axis 6, the oblique surfaces 9, 9′ each merge with an arcuate segment 12 into a surface 13 which extends perpendicularly with respect to the axis 6 of the pressure piece 5. Here, the radius Rₛ of the arcuate segments 12 is larger than the radius R_{w} of the rolling bodies 8, 8′ or balls 15, 15′.

The depth of the turned groove is selected such that it is smaller than the diameter of the rolling bodies 8, 8′. This brings about the situation where the pressure piece 5 is supported axially on the setting screw 16 exclusively via the rolling bodies 8, 8′, irrespective of the respective operating path covered during operation of the steering system.

During operation of the steering system, the rack 28 and the pressure piece 5 are pressed away from the pinion 27 by the toothing engagement angle as a result of a steering force being introduced onto the pinion 27 and/or restoring forces from the steerable vehicle wheels, which restoring forces act on the rack 28.

The balls 15, 15′ are pressed radially with respect to the axis 6 as a result, counter to the spring force F_{f} of the spring 11. On account of the selected geometric variables of the opening angle α of the oblique surfaces 9, 9′ and the radius Rₛ of the arcuate segments 12, the ratio of the thrust force Fₐ of the pressure piece 5 to the spring force F_{f} changes as a function of the respective point of contact of the rolling bodies 8, 8′ on the flanks of the setting screw turned groove, the thrust force Fₐ of the pressure piece 5 rising with increasing compression of the spring 11.

The spring element 7 makes permanent, jolt-free contact possible for the pressure piece 5 on the mechanism casing 26 via the rolling bodies 8, 8′, as a result of which rattling noise is avoided. As a result, the adjusting function and spring function are united in a single spring element. The spring element is simple to install, of small overall size and has only few parts.

Further possible refinements of the thrust device 1 are feasible, for instance with an oblique surface angle α which opens radially away from the axis 6 of the pressure piece 5, and with rolling bodies which are spring loaded in the direction of the axis 6. It can also be expedient to arrange the oblique surfaces or the frustoconical turned groove in the pressure piece instead of in the setting screw or a frame part.

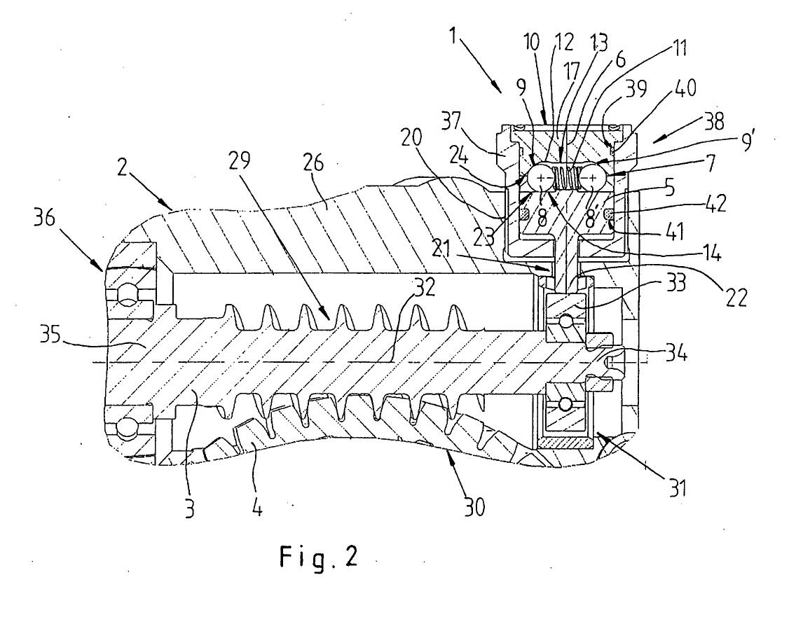

The thrust device can also be used for other purposes, such as for pressing a first mechanism member 3 which is configured as a worm 29 against a second mechanism member 4 which is configured as a worm gear 30, and vice versa (cf. FIG. 2). FIG. 2 shows a worm gear mechanism in a cross section along an axis 32 of a worm 29, which worm gear mechanism is preferably used for force transmission of a servomotor in a steering column drive, a pinion drive or double pinion drive of an electric power steering system.

The worm 29 which is configured as a first mechanism member 3 is held in a radially displaceable bearing 33 in a frame 2 which is configured as a mechanism casing 26. The bearing 33 is arranged at the axial end 34 of the worm 29. The worm 29 is held in the mechanism casing 26, in a further bearing 36, at its end 35 which lies opposite the axial end 34. The bearing 36 is configured as a pivotable locating bearing. The worm 29 is connected fixedly to a servomotor (not shown) so as to rotate with it via a clutch and is in engagement with a worm gear 30. As a second mechanism member 4, the worm gear 30 forms the output side of the worm gear mechanism. In the exemplary embodiment shown, the axis of the worm gear 30 is arranged in the perpendicular direction with respect to the axis 32 of the worm 29. In order to ensure the absence of play in the toothing engagement of the worm 29 and worm gear 30 during operation of the worm gear mechanism irrespective of wear, of thermal expansion and the like, a thrust device 1 is arranged in the mechanism casing 26.

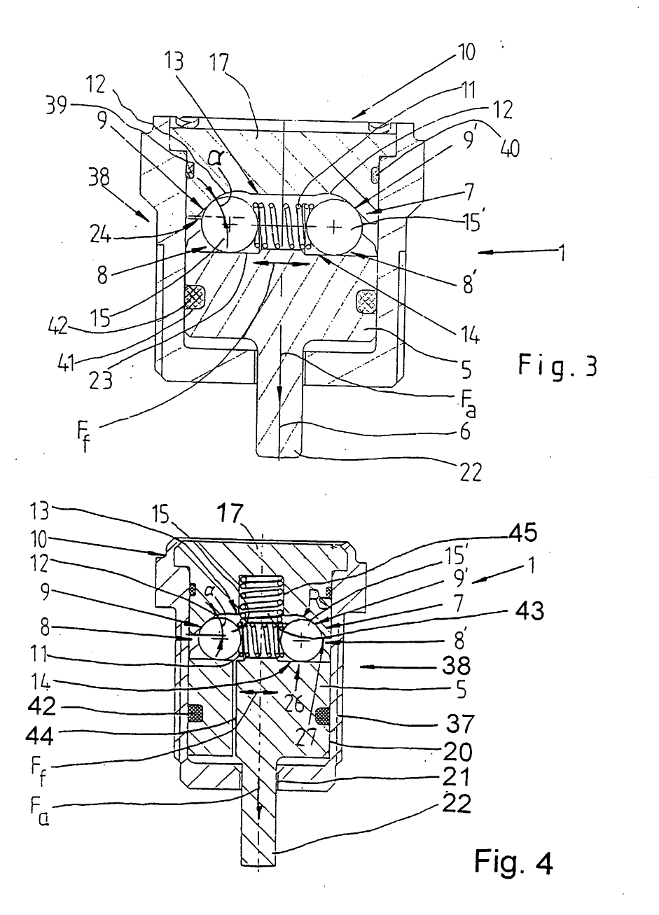

FIG. 3 shows an enlarged illustration of the thrust device 1 in a longitudinal section along an axis 6 of a pressure piece 5. The same designations as in FIG. 2 apply for identical components. The pressure piece 5 is of cylindrical form and is inserted in a hole in the mechanism casing 26. The pressure piece 5 is held in the hole so as to be displaceable along the axis 6 which is oriented in the perpendicular direction with respect to the axis 32 of the worm 29 and in the perpendicular direction with regard to the axis of the worm gear 30. In its axial end which faces the worm 29, the hole has an opening 21 through which a pressure piece end 22 protrudes. The pressure piece end 22 and the opening 21 have a smaller diameter or free width than the pressure piece 5 itself. The pressure piece end 22 can act on a bearing 31 of the first or second mechanism member and, in the exemplary embodiment shown, acts on the bearing 33 and presses the worm 29 in the radial direction of its axis 32 toward the worm gear 30. For this purpose, a spring element 7 is provided which is arranged in the hole. The spring element 7 is supported on a base 23 of the pressure piece 5, which base 23 is configured as a flat surface 14 or, as shown in FIGS. 2 and 3, is configured as a cylindrical surface, as viewed transversely with respect to the axis 6. As viewed in the axial direction of the axis 6, the spring element 7 is supported on a frame part 10 which is configured as a cover 17.

The spring element 7 is formed from two rolling bodies 8, 8′ which lie opposite one another diametrically with respect to the axis 6 and are configured as balls 15, 15′. A spring 11 which is configured as a helical compression spring is inserted between the rolling bodies 8, 8′, the radius of the spring being smaller than the radius R_{w} of the rolling bodies 8, 8′.

The spring 11 and the balls 15, 15′ are guided in a half-open hole. A frustoconical turned groove is made in an end surface 24 of the cover 17. In the cross section shown, the turned groove has oblique surfaces 9, 9′ which are configured in each case with an angle α which opens radially toward the axis 6. As viewed in the radial direction with respect to the axis 6 of the pressure piece 5, the oblique surfaces 9, 9′ each merge with an arcuate segment 12 into a surface 13 which extends perpendicularly with respect to the axis 6 of the pressure piece 5. Here, the radius Rₛ of the arcuate segments 12 is larger than the radius R_{w} of the rolling bodies 8, 8′ or balls 15, 15′.

The parts are dimensioned in such a way that the pressure piece 5 is supported axially on the cover 17 exclusively via the rolling bodies 8, 8′, irrespective of the respective operating path covered during operation of the thrust device 1. In order to reduce friction between the rolling bodies 8, 8′, the cover 17 and the pressure piece 5 and the associated hysteresis in the movement sequence of the pressure piece 5, a compression spring 43 can be provided which acts on the pressure piece 5. As FIG. 4 shows, the compression spring is arranged in a blind hole 45 of the cover 17 in the region of its surface 13. The compression spring 43 which is formed as a cylindrical helical compression spring has a spring force which is greater than that of the spring 11. The compression spring 43 thus brings about the majority of the thrust force Fₐ of the pressure piece 5.

During operation of the steering system, the worm 29 and the pressure piece 5 are pressed away from the worm gear 30 by the toothing engagement angle as a result of a motor torque being introduced onto the worm 29 and/or restoring forces from the steerable vehicle wheels, which restoring forces act on the worm gear 30.

The balls 15, 15′ are pressed radially with respect to the axis 6 as a result, counter to the spring force F_{f} of the spring 11. On account of the selected geometric variables of the opening angle α of the oblique surfaces 9, 9′ and the radius Rₛ of the arcuate segments 12, the ratio of the thrust force Fₐ of the pressure piece 5 to the spring force F_{f} changes as a function of the respective point of contact of the rolling bodies 8, 8′ on the flanks of the cover turned groove, the thrust force Fₐ of the pressure piece 5 rising with increasing compression of the spring 11. In the region of the arcuate segment 12, however, the thrust force Fₐ rises rapidly without a jump and free of jolts.

The spring element 7 makes permanent, jolt-free contact possible for the pressure piece 5 on the mechanism casing 26 via the rolling bodies 8, 8′, as a result of which rattling noise is avoided. As a result, the adjusting function and spring function are united in a single spring element. The spring element is simple to install, of small overall size and has only few parts.

In the exemplary embodiment shown, the cover 17 is calked to a casing 37 which combines the pressure piece 5, the spring element 7 and the cover 17 to form a unit, a pressure piece assembly 38. The cover 17 is sealed against the casing 37 via an O-ring 40 which is inserted in a peripheral groove 39 of the cover 17. The pressure piece 5 which is held axially displaceably in the casing 37 is optionally sealed against the casing 37 with an O-ring 42 which is inserted into a peripheral groove 41 in the pressure piece 5 and also serves for damping. As shown in FIG. 4, a hole 44 is guided axially through the pressure piece. The hole 44 serves for ventilation of the space between the cover 16 and the pressure piece 5.

In the exemplary embodiment shown in FIGS. 2 and 3, the casing 37 is of cylindrical configuration and is screwed into the mechanism casing in a sealing manner. It can also be expedient to allow the pressure piece to act on a bearing of the worm gear 30. Instead of the application of the thrust device 1 according to the invention for pressing mechanism members which are engaged with one another with a form-fitting connection, the thrust device can also be used in the case of mechanism members which are in frictional engagement.

1. A thrust device for a roller cam mechanism in a steering system, having a frame on which a first mechanism member is arranged in engagement with a second mechanism member, and having a pressure piece which is mounted on the frame so as to be displaceable along an axis, a spring element for pressing the first mechanism member and the second mechanism member against one another acting on the pressure piece, the spring element being supported on oblique surfaces between the pressure piece and a frame part, the spring element being formed from rolling bodies which are spring loaded approximately transversely with respect to the axis of the pressure piece and the oblique surfaces are configured with an angle which opens radially toward the axis of the pressure piece, and the rolling bodies are spring loaded by a spring radially in the direction away from the axis of the pressure piece.

2. The thrust device, as claimed in claim 1 wherein, the pressure piece is spring loaded by a compression spring in the direction of the axis.

3. (Canceled)

4. The thrust device as claimed in claim 1 wherein, the spring extends in each case between the two rolling bodies.

5. (Canceled)

6. The thrust device as claimed in claim 1 wherein, the oblique surfaces merge with an arcuate segment having a radius into a surface which extends approximately perpendicularly with respect to the axis of the pressure piece.

7. The thrust device as claimed in claim 6, wherein, the radius of the arcuate segment is larger than the radius of the rolling bodies.

8. The thrust device as claimed in claim 1 wherein, the oblique surfaces are arranged in the pressure piece.

9. The thrust device as claimed in claim 1 wherein, the oblique surfaces are arranged in the frame part.

10. The thrust device as claimed in claim 1 wherein, as viewed in the axial direction of the axis of the pressure piece, a flat surface or, as viewed transversely with respect to the axis, a cylindrical surface lies opposite the oblique surfaces.

11. The thrust device as claimed in claim 1 wherein, the rolling bodies are balls.

12. The thrust device as claimed in claim 1 wherein, the compression spring has a greater spring force than the spring which loads the rolling bodies.

13. The thrust device as claimed in claim 1 wherein, the spring force of the compression spring is less than 20 N.

14. The thrust device as claimed in claim 1 wherein, the frame part is a setting screw.

15. The thrust device as claimed in claim 1 wherein, the frame part is a cover which is positioned fixedly, preferably calked, in the frame.

16. The thrust device as claimed in claim 1 wherein, the pressure piece is penetrated by a hole in the axial direction.

17. The thrust device as claimed in claim 1 wherein, the frame is a mechanism casing.

18. The thrust device as claimed in claim 1 wherein, the first mechanism member is a worm and the second mechanism member is a worm gear.

19. The thrust device as claimed in claim 1 wherein, the pressure piece acts on a bearing of the first and/or second mechanism member.

20. The thrust device as claimed in claims 1 wherein, the pressure piece, the spring element, the compression spring and the frame part are combined in a casing as a pressure piece assembly.

21. The thrust device as claimed in claim 1 wherein, the first mechanism member is a pinion and the second mechanism member is a rack.
